(19) United States
(12) Patent Application Publication
(10) Pub. No.: US 2016/0123376 A1
(43) Pub. Date: May 5, 2016

(54) TELESCOPIC DRIVE SHAFT

(71) Applicant: Daimler AG, Stuttgart (DE)

(72) Inventor: Frank BUSCHBECK, Sindelfingen (DE)

(73) Assignee: Daimler AG, Stuttgart (DE)

(21) Appl. No.: 14/896,349

(22) PCT Filed: May 23, 2014
(86) PCT No.: PCT/EP2014/001397

§ 371 Date: Dec. 4, 2015

(30) Foreign Application Priority Data
Jun. 5, 2013 (DE) 10 2013 009 497.6

(51) Int. Cl. F16C 3/02; F16C 3/03

(52) U.S. Cl. CPC F16C 3/023; F16C 3/026; F16C 3/03

(57) ABSTRACT

A drive shaft having at least one outer shaft section having a hollow end section and at least one inner shaft section which penetrates along a first penetrating depth into the hollow end section of the outer shaft section, is disclosed. The shaft sections are connected firmly to a contact surface between an outer wall of the inner shaft section and an inner wall of the outer shaft section along the first penetrating depth. The firm connection has a longitudinal axis load-bearing capability which is lower than a predefined buckling force which leads to the buckling of the shaft sections in the case of longitudinal axis loading of the drive shaft. In the case of application of an axial force which is greater than the buckling force, the inner shaft section can penetrate more deeply than the first penetrating depth into the hollow end of the outer shaft section.

### BACKGROUND AND SUMMARY OF THE INVENTION

The present invention relates to a drive shaft for a motor vehicle.

For motor vehicles, the engine of which is not coupled directly to the driven axle, drive shafts having one or more joints are used which couple the engine and the axle drive for torque transfer along the vehicle longitudinal axis. The shafts are mostly executed to be very solid for the torque transfer, for example as a hollow shaft made from steel, but due to this solid and stiff construction, in the case of a crash, this represents a considerable risk of injury for the passengers of the vehicle and for the other party in the crash. Ever stricter requirements for crash behavior, both for passenger protection and for the protection of the other party in the crash, therefore make it necessary to also include the drive shaft in the crash concept.

Telescopic steering columns are known which can be pushed together in the event of a crash such that they do not penetrate the interior in the event of impact. Drive shafts have also been developed which can both transfer the required torque and fail in the case of exceeding a defined axial force load and can be pushed together in a telescopic manner, so for example drive shafts having a puncture joint.

Additionally a fiber-reinforced drive shaft is known from DE 10 2009 009 682 A1 which has two shaft sections which are connected by a transfer section which is a target breaking section which breaks in the case of exceeding a limit pressure load. The target break section has a curved cross-section. The one shaft section therein has a smaller diameter than the other shaft section such that it can penetrate another shaft part in the case of failure of the target break section.

DE 101 04 547 A1 also relates to a drive shaft which is able to be pushed together axially and which consists of a single material piece which has, however, several sections; a first shaft section and a second shaft section, which are connected by a target break section. The target break section has a circumferential bulge to which a receiving section connects in the direction of the other shaft section, the diameter of which is larger than that of the first wave shaft. In the case of a defined axial force load, the bulge begins to deform due to the occurring bending moment in the edge fibers, until it fails and the material cohesion dissolves. The first shaft section can now move into the receiving section, whereby the total length of the shaft is shortened.

Finally, a connection of a hollow shaft made from a fiber reinforced material which is coupled at the end with a pin, is known from DE 37 25 959 A. The diameter of the pin is therein greater than the inner diameter of the hollow shaft, which is why the hollow shaft is widened for the connection and the pin can be held in a non-positive manner. On exceeding a limit torque, the non-positive connection slips.

The release force can, in the case of the known telescopic drive shafts, however, not be adjusted without the shaft body having to be re-dimensioned as the release force is determined crucially from the geometry and the material properties of this shaft body. Because of the comparatively complex geometry in the target break sections, each adaptation of the release force is therefore able to be achieved only with increased expenditure, as new molds for the production, for example by die forging or hydro forming, must also always be produced to change the geometry of target break section.

Based on this prior art, the object of the present invention is to create an improved drive shaft which is able to be pushed together and can be formed from fewer semi-finished products. Furthermore it is desirable that it enables the dimensioning of the release force without exchange of the substantial shaft components and that it is produced more favorably than known telescopic drive shafts.

The drive shaft according to the invention has, in a first exemplary embodiment, at least one outer shaft section having a hollow end section which has a cylindrical inner cross-section, and at least one inner shaft section which is penetrated along a first penetrating depth into the hollow end of the outer shaft section. The shaft sections are connected to a contact surface between the outer wall of the inner shaft section and the inner wall of the outer shaft section along the first penetrating depth in a firmly bonded manner. The firm connection has a longitudinal axis load-bearing capability which is lower than a predefined buckling force which leads to the buckling of the shaft section in the case of longitudinal axis loading of the drive shaft. In the case of application of an axial force which is greater than the buckling force, the inner shaft section can penetrate more deeply than the first penetrating depth into the hollow end of the outer shaft section.

“Load-bearing capability” herein means overall load-bearing capability of the adhesive connection which leads to a failure of the same. In order to obtain a firm connection with sufficient load-bearing capability, the inner cross-section of the hollow cylindrical end section of the outer shaft section along the first penetrating depth is to correspond to the outer cross-section of the inner shaft section, whilst the column width must be adapted to the used additive of the firm connection. The operational torque is finally transferred via the additive in the annular gap between the inner shaft section and the outer shaft section.

Using the solution according to the invention it is possible to construct a telescopic drive shaft from comparatively simple semi-finished products, for example cylindrical tubes, the release force of which can be adjusted very simply and without changes to the geometry of the shaft sections. The force which leads to the failure of the firm connection can be determined simply by changing the penetrating depth, the strength of the additive and by the gap width between the inner and the outer shaft section.

The torque to be transferred is also included in a suitable manner in the dimensioning of the firm connection. The force which leads to failure is, however, to be at a maximum only as high as the force which would lead to the failure of the narrower shaft section through buckling. By suitable design of the connection, a virtually constant (or also predefined, for example, path dependent) force level is adjusted over the whole push path which provides the optimum characteristic line for the relevant crash load cases in the whole vehicle. The force to push together the shaft is preferably adjusted to a range from 40 to 80 kN. The drive shaft according to the invention therefore does not buckle during a crash, but can be pushed together under the occurring axial force load during the crash, whereby the risk of injury for vehicle passengers as well as the other crash party can be reduced.

The drive shaft can thereby be produced more cost-effectively than known telescopic drive shafts, as to achieve different release forces, the same shaft sections can always be used and only changes to the firm connection are necessary. Therefore both construction and storage costs can be reduced.

The cross-section of the shaft sections can advantageously be circular, as a homogeneous stress distribution and a good material use result in the case of torsional loading.

In a further embodiment, one or both shaft sections can consist, at least along one longitudinal axis section, of a fiber-reinforced material, wherein a fiber-reinforced plastic, in particular CFRP or GFRP, is advantageous.

If the drive shaft consists of the fiber-reinforced material, known advantages with regard to increased torsional rigidity at a reduced weight as well as increased driving dynamics in the overall vehicle system can be achieved, as a lower mass must be accelerated.

The fiber types referred to are not to be understood as limiting, rather, if it appears to be useful, other fiber types can also be used, for example aramid fibers. It can also be provided that the shaft sections only consist of fiber-reinforced material along a longitudinal axis section, for example in the section in which they are connected to the respective other shaft section.

In a still further embodiment, the firm connection can be a fiber-free connection, wherein an adhesive connection or a connection which is formed by a matrix material of the at least one shaft section made from the fiber-reinforced material is advantageous.

The fiber-free connection is advantageous because the mechanical properties of pure materials are more predictable than the fiber-reinforced materials, since these often aging effects cause the mechanical properties to change over the course of time. Therefore the release force of the drive shaft can be sufficiently accurately dimensioned and based on this, the dimensioned “release force” also does not substantially change after a long duration of use. The failure mechanism of a fiber-free connection is also a different one; so for example, after the failure, no sharp break edges and open fiber-ends result which can reduce the risk of injury, in particular also during recycling.

According to a further embodiment, the shaft section made from the fiber-reinforced material can demonstrate a fiber alignment in which the fibers come to lie at an angle in the range from 25° to 70′ with regard to the longitudinal axis; an angle in a range from 35° to 55° is also considered as advantageous and a range from 40° to 50° as particularly advantageous.

The described fiber orientation is advantageous for a torsion-loaded drive shaft, as the longitudinal axis of the fibers is therefore aligned according to the flow of force. In order to better maintain the position of alternating torsional loads, the fibers can also be arranged to cross. The production of such a fiber material hose is, for example, possible by pultrusion and is able to be automated well. Likewise, prepregs or preforms can also be used.

If a constant outer diameter is implemented, or further adjustment parameters must be used with regard to the adjustment of the load level and course behavior, the target breaking surface can also be implemented to be tiered between the individual fiber layers. This means that several fiber layers are separated from one another within a tubular shaft section, in each case by fiber-free adhesive surfaces or a fiber free matrix region arranged therebetween. In the event of a crash, the regions without fiber composite, i.e. made from adhesive or matrix, then fail in a defined manner, and the two tube halves are firstly pushed over each other and then—in the case of corresponding course length—also into each other. Preferably a controlled increase of the load level on the end takes place. It is important that the drive shaft yields to a force level which is as constant and well-defined as possible. The level of this force preferably lies at a value in the range from 40 to 80 kN, particularly preferably at 50 or 80 kN.

Furthermore, a second inner shaft section, which is connected along a longitudinal axis section to the inner shaft section, can be guided coaxially over the inner shaft section. A first circumferential gap of predefined longitudinal axis extension is provided between the hollow end section of the outer shaft section and the opposite end of the second inner shaft section, the gap serving as a stop for the outer shaft section.

The term “end” is herein to be understood with regard to the longitudinal axis extension of the shaft sections, such that the circumferential gap is located between opposite front surfaces of the two shaft sections. A drive shaft is hereby obtained which virtually has a constant outer cross-section over the entire length; only at the position of the circumferential gap does the drive shaft have a smaller cross-section. Advantageously, in this embodiment, the maximum telescoping path of the drive shaft can be limited by the longitudinal axis extension of the circumferential gap, as it serves as a stop during displacement.

Additionally, a second outer shaft section can be guided coaxially over the outer shaft section, the second outer shaft section being connected to the outer shaft section along a longitudinal axis section. The second outer shaft section is connected to the second inner shaft section along a second penetrating depth. The firm connection has a longitudinal axis load-bearing capability which is lower than the predefined buckling force which leads to the buckling of the second shaft section during longitudinal axis loading of the drive shaft. During application of an axial force which is greater than the buckling force, the second inner shaft section can be penetrated more deeply than the second penetrating depth into the second outer shaft section.

In this embodiment, an arrangement is again produced and pushed radially outwards over the drive shaft. A higher torque can therefore be transferred and also the axial force, in the case of which the firm connection fails, can be selected to be higher as this axial force is now distributed over two firm connections. If shaft sections made from fiber reinforced plastic are concerned, the drive shaft can be produced according to this embodiment simply by “stacking” and subsequent lamination of individual shaft blanks.

According to a further embodiment, a predefined number of further inner shaft sections and/or outer shaft sections can be guided over the second inner shaft section and the second outer shaft section. An n^{th} circumferential gap having a predefined longitudinal axis extension is located in each case between opposite ends of an n^{th} inner shaft section and an (n−1)^{th} outer shaft section.

Since radially exterior further shaft sections are “stacked” over the second shaft section, virtually according to the Matroschka principle, the maximum transferable torque as well as the attenuating properties of the shaft can be targetedly dimensioned, where the attenuating properties are determined substantially by the properties of the additive in the annular gaps. However, the axial force which leads to the “releasing” of the firm connections can also be dimensioned in that the penetrating depths of the n^{th} inner and the n^{th} outer shaft section, as well as the strength of the firm connections, are included in the design. It can also be provided that the shaft section of highest “order” is an inner shaft section which is not guided in an outer shaft section of the same order, so virtually a compensating sleeve. The outer cross-section of this compensating sleeve can particularly advantageously correspond to the outer cross-section of the outer shaft section which is arranged opposite in the longitudinal axis, as a drive shaft can therefore be obtained having a constant outer cross-section therebetween until the circumferential gap.

This and further advantages are represented by the following description with reference to the accompanying figures. The reference to the figures in the description serves to support the description and to facilitate the understanding of the object. Objects or parts of objects which are substantially the same or similar may be provided with the same reference numeral. The figures are only a schematic depiction of one embodiment of the invention.

### BRIEF DESCRIPTION OF THE DRAWINGS

FIG. 1 is a longitudinal cut of the drive shaft which is able to be pushed together,

FIG. 2 is a longitudinal cut of a further drive shaft which is able to be pushed together.

### DETAILED DESCRIPTION OF TUE DRAWINGS

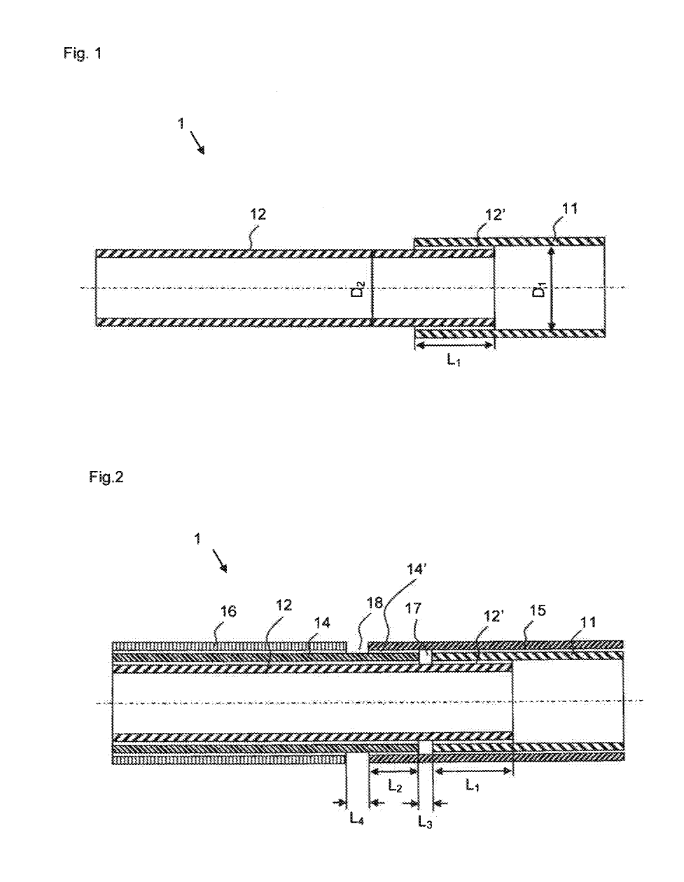

A simple design of the drive shaft 1 according to the invention is shown in FIG. 1. The inner shaft section 12 is introduced along the penetrating depth L1 into the outer shaft section 11. It can be recognized that the outer diameter D2 of the inner shaft section 12 is smaller than the inner diameter D1 of the outer shaft section 11, which is why an annular gap 12′ is located therebetween. The two shaft sections 11,12 are cylindrical at least at their ends which are guided into each other, wherein it can be that the shaft sections 11,12 have another shape outside of the end section; they can of course also be cylindrical over the complete length. In particular, the cross-section can be circular, as the best use of material in the case of torsional loading results with a circular cross-section. The two shaft sections 11,12 are connected firmly along the annular gap 12′ such that an operational torque can be transferred via this connection. The size of the transferable operational torque can be adjusted, maintaining the dimensions of the two shaft sections 11,12 solely by changing the penetrating depth L1 and by the strength of the firm connection in the annular gap 12′. The firm connection can be achieved by using an additive, for example an adhesive. If the shaft sections 11, 12 are FRP tubes, then the additive can also be the matrix plastic of the FRP tube, as this is known to be very good at producing a firm connection with the shaft sections 11,12.

If the drive shaft 1 is loaded by an axial force, such as, for example, in the event of a crash, then the firm connection in the annular gap 12′ fails in the case of exceeding of a limit force. The limit force can be dimensioned via the possibilities described above and is to be selected to only be so large that it is ensured that none of the shaft sections 11,12 fail due to buckling, as this represents an increased risk of injury. After the failure of the firm connection, the inner shaft section 12 penetrates into the outer shaft section 11; if this is a tube, the penetration path is in principle unlimited. It is however also conceivable that only the end section of the outer shaft section 11 which receives the inner shaft section 12 is hollow and the rest is a full shaft; then the penetrating path is limited which, however, is not shown in the Figure. In such a case, it can even be advantageously possible that after reaching this stop, further energy is dissipated by crushing the FRP shaft sections. Advantageously, the shaft sections made from FRP are produced by pultrusion, where the fibers in particular can be arranged according to load flow, approximately at a ±45° angle, which cannot be gleaned, however, from FIG. 1.

The drive shaft 1 according to the invention, however, not only offers the advantage that it can be pushed together in the event of a crash, rather it is also possible to limit the maximum transferable torque via the dimensioning of the firm connection in the annular gap 12′, which, for example if the drive train is suddenly blocked whilst driving, is advantageous as a dangerous blocking of the driven axle can therefore be effectively prevented, as the drive shaft 1 virtually acts as a slipping clutch.

In FIG. 2, another embodiment of the drive shaft 1 is depicted in the longitudinal cut. The basic construction having an inner shaft section 12 and an outer shaft section 11 corresponds to the drive shaft 1 which is shown in FIG. 1.

In order to be able to transfer a greater torque or in order to obtain a greater release force of the firm connection in the annular gap, inner and outer shaft sections 11,12 known from FIG. 1 which here form first shaft sections, further inner and outer shaft sections 14,15,16 are arranged in an outward direction. A second inner shaft section 14 is guided over the inner shaft section 12, the inner cross-section of which corresponds to the outer cross-section of the first inner shaft section 12, whilst the two shaft sections 12,14 are connected to each other. A circumferential gap 18 which extends in the longitudinal direction of the shaft 1 is located between opposite front surfaces of the second inner shaft section 14 and the first outer shaft section 11. This gap 17 defines the maximum displacement path of the first inner shaft section 12 and of the first outer shaft section 11 after the failure of the firm connection 12′. Further outside, a second outer shaft section 15 is connected to the first outer shaft section 11 which is pushed along the predefined penetrating depth L2 over the inner shaft section of second order 14, with which it is connected firmly on the length L2. This firm connection in the annular gap 14 additionally contributes to the firm connection in the annular gap 12′ for the force and torque transfer of the drive shaft 1. In this embodiment of the shaft, before the drive shaft 1 is pushed together, both firm connections in the annular gap 12′,14′ must have failed, whilst the maximum telescoping path is additionally also limited to the circumferential gap 17 by the second circumferential gap 18. The circumferential gap 18 extends with the length L4 along the longitudinal axis and is located between opposite front surfaces of the second outer shaft section 15 and a third inner shaft section 16 which is striped as a sleeve 16 over the second inner shaft section 14. Using the sleeve 16 it is achieved that the drive shaft 1 virtually has the same outer diameter over its entire length, wherein this is “interrupted” only by the circumferential gap 18.

1-8. (canceled)

9. A drive shaft, comprising:
an outer shaft section having a hollow end section having a cylindrical inner cross-section; and
an inner shaft section which penetrates at least along a first penetrating depth into the hollow end section of the outer shaft section;
wherein the outer shaft section and the inner shaft section are connected by a first firm connection between an outer wall of the inner shaft section and an inner wall of the outer shaft section along the first penetrating depth, wherein the first firm connection provides a first longitudinal axis load-bearing capability which is lower than a predefined first buckling force that buckles the outer shaft section and the inner shaft section during a longitudinal axis loading of the drive shaft, and wherein in a case of an application of an axial force which is greater than the predefined first buckling force the inner shaft section is penetrateable more deeply than the first penetrating depth into the hollow end section of the outer shaft section;
wherein at least one of the outer shaft section and the inner shaft section consists of a fiber-reinforced plastic at least along a longitudinal axis section and wherein the first firm connection is a fiber-free connection which is formed from an adhesive or is formed from a matrix material of the at least one of the outer shaft section and the inner shaft section.

10. The drive shaft according to claim 9, wherein the at least one of the outer shaft section and the inner shaft section has a fiber alignment with regard to a longitudinal axis in a range from 25° to 70°.

11. The drive shaft according to claim 9, further comprising a second inner shaft section which is disposed coaxially over the inner shaft section and which is connected to the inner shaft section, wherein a first circumferential gap of a predefined longitudinal axis extension is present between the hollow end section of the outer shaft section and an end of the second inner shaft section and wherein the gap is a stop for the outer shaft section.

12. The drive shaft according to claim 11, further comprising a second outer shaft section which is disposed coaxially over the outer shaft section and which is connected to the outer shaft section and which is connected to the second inner shaft section along a second penetrating depth, wherein a second firm connection provides a second longitudinal axis load-bearing capability which is lower than a predetermined second buckling force that buckles the second inner shaft section and the second outer shaft section in a case of longitudinal axis loading of the drive shaft, and wherein in a case of application of an axial force which is greater than the second buckling force, the second inner shaft section is penetrateable more deeply than the second penetrating depth into the second outer shaft section.

13. The drive shaft according to claim 12, wherein a predefined number of further inner shaft sections and outer shaft sections are disposed over the second inner shaft section and the second outer shaft section, respectively, and wherein a respective circumferential gap having a predefined longitudinal axis extension is present between respective ends of each of the predefined number of further inner shaft sections and outer shaft sections.

14. A drive shaft, comprising:
an outer shaft section having a hollow end section having a cylindrical inner cross-section; and
an inner shaft section which penetrates at least along a first penetrating depth into the hollow end section of the outer shaft section;
wherein the outer shaft section is connected to the inner shaft section via an adhesive connection as a non-positive bond and wherein the non-positive bond is adjustable such that the outer shaft section and the inner shaft section are pushable into each other in a case of an axis loading above 40 kN.
